(19) United States
(12) Patent Application Publication
(10) Pub. No.: US 2005/0199449 A1
(43) Pub. Date: Sep. 15, 2005

(54) Wheelchair wheel immobilizer

(76) Inventors: Keith A. Tanksley, Nicholasville, KY (US); Bruce S. Donaldson, Lexington, KY (US)

Correspondence Address: KING & SCHICKLI, PLLC, 247 NORTH BROADWAY, LEXINGTON, KY, 40507, US

(21) Appl. No.: 10/521,545

(22) PCT Filed: Jul. 17, 2003
(86) PCT No.: PCT/US03/22286

§ 371 Date: Jan. 14, 2005

Related U.S. Application Data
(60) Provisional application No. 60/396,918, filed on Jul. 17, 2002.

(51) Int. Cl. B62B 5/04

(52) U.S. Cl. 188/19

(57) ABSTRACT

A wheel immobilizer for substantially preventing rotation of a wheelchair wheel or tire about a central axis thereof is provided comprising a pivoting wheel stop carrying a detent and a rotating cam having a receiver. The detent seats in the receiver when the wheel immobilizer is in an unlocked position (with the wheel stop held at a spaced distance from the wheel) to allow rotation thereof. A lever is operably connected to the cam, whereby actuating the lever rotates the cam and unseats the detent from the receiver, urging a wheel-contacting surface of the wheel stop into locking contact with the wheel. In another aspect, a wheel locking assembly is provided comprising paired wheel immobilizers as described which may be operated independently. In still another aspect, a wheel locking assembly is provided comprising a first and second wheel immobilizer, wherein the first and second wheel immobilizers are operably linked by a flexible linkage.

This application claims the benefit of priority in U.S. Provisional Patent Application Ser. No. 60/396,918, filed Jul. 17, 2002.

### FIELD OF THE INVENTION

This invention relates generally to the field of wheel locking mechanisms for wheelchairs. In particular, the present invention relates to a push-pull wheelchair lock whereby a wheel of a wheelchair may be immobilized by either pulling up or pushing down on the lock. The wheelchair wheel lock of the present invention is adapted for use by individuals who may be unable to operate conventional push-pull locks, providing improved wheel locking power with use of minimal force.

### BACKGROUND OF THE INVENTION

It is known to provide wheelchairs with mechanisms for locking the wheels thereof, preventing the wheelchairs from traveling except at the urging of the user or an assistant. One design of wheelchair lock incorporates a “push-pull” mechanism comprising a lever operably connected to a wheel strike, whereby the user may lock a wheel of a wheelchair by either pushing forward or pulling back on the lever. Such push-pull wheel locks are suitable for their intended purpose.

However, improvements to conventional push-pull wheel locking mechanisms are desirable. Conventional push-pull wheel lock designs generally can only operate in the “push” or the “pull” configuration, and must be disassembled and reconfigured to convert them from the push function to the pull function. Further, such push-pull locks often have relatively short operating levers which, while avoiding inconvenience to the user, may require a level of strength which certain handicapped individuals may simply not possess. Simply elongating the operating lever to improve the leverage thereof may not be convenient, as an elongated lever may be obtrusive to the user.

There have been attempts to address this deficiency of conventional push-pull wheel locks. Commonly, a system of toggle joints and linkages allowing movement of a wheel strike surface into contact with a wheel are used. Alternatively, it is known to provide a system of linkages in combination with wheel strikes having more than one wheel-contacting surface, wherein pushing an operating lever will cause a first wheel-contacting surface to immobilize a wheel, and pulling the lever will cause a second wheel-contacting surface to immobilize the wheel.

Various combinations of these systems are known in the art, and appear generally effective for their intended purpose. However, significant improvements are possible. Multiple linkages and wheel-contacting surfaces add complexity and weight to a wheel lock, increasing both the cost of manufacture (and the subsequent cost to the user) and the likelihood of component failure necessitating repair. It is also desirable to provide an elongated operating lever which, when the wheelchair wheel lock is in the locking position, may be conveniently placed in a storage position out of the way of the wheelchair user or persons assisting the wheelchair user, without altering the wheel-immobilizing force applied by the lock.

Therefore, a need in the art exists for a push-pull wheel locking mechanism which does not suffer from the complexity and disadvantages of conventional push-pull wheelchair locks as described above. Such a push-pull wheel locking mechanism should preferably be adaptable for affixation or retrofitting to any standard wheelchair design.

### SUMMARY OF THE INVENTION

In one aspect, the present invention provides a wheel immobilizer for substantially preventing rotation of a wheelchair wheel or tire about a central axis thereof. The wheel immobilizer may comprise a pivoting wheel stop carrying a detent and a rotating cam having a receiver in which the detent seats when the wheel immobilizer is in an unlocked position (with the wheel stop held at a spaced distance from the wheel) to allow rotation thereof. A lever is operably connected to the cam, whereby actuating the lever in a forward or backward direction rotates the cam and unseats the detent from the receiver, urging a wheel-contacting surface of the wheel stop into locking contact with the wheel. The cam may be substantially circular in shape.

Typically, the lever of the present invention may include a first, gripping end, a central shaft, and a second, cam end having a receiver in which the detent seats when the wheel immobilizer is in an unlocked position with the wheel stop held at a spaced distance from the wheel to allow rotation thereof. In this fashion, the need to indirectly connect the operating lever and the cam element is obviated. The cam end of the lever may be substantially circular in shape. It will be appreciated that the wheel stop, cam, and lever may be directly affixed to a wheelchair frame. More typically, the wheel stop, cam, and lever may be supported by a mounting block of a type known in the art, adapted for mounting to a frame of a wheelchair. In this way, a unit assembly is provided which may be retrofitted to any existing wheelchair.

In another aspect, a wheel locking assembly for substantially preventing rotation of a wheelchair wheel or tire about a central axis thereof is provided, comprising a first and a second wheel immobilizer substantially as described above. Each wheel immobilizer may be respectively held at a spaced distance from a first and second wheel of a wheelchair, typically the large primary drive wheels of the chair. It will be appreciated that in this embodiment the wheel immobilizers are separately and independently operable to lock the wheels of a wheelchair.

In yet another aspect of the invention, a wheel locking assembly for substantially preventing rotation of a wheelchair wheel or tire about a central axis is provided, comprising a first wheel immobilizer and a second wheel immobilizer for mounting to a wheelchair frame at a spaced distance from a first and second wheel of a wheelchair, typically the primary drive wheels. The first wheel immobilizer is substantially as described above, including a first pivoting wheel stop carrying a detent, a rotating cam having a receiver in which the detent seats when the wheel immobilizer is in an unlocked position, and a lever operably connected to the cam. The second wheel immobilizer is described in greater detail in U.S. patent application Ser. No. 10/328,780 and copending PCT patent application S.N. PCT/US02/41082, both entitled Wheelchair Wheel Lock and both incorporated in their entirety by reference herein.

The second wheel immobilizer includes a second pivoting wheel stop which is operably connected to the first wheel stop by a substantially continuously flexible linkage, whereby actuating the lever to urge the first wheel stop wheel-contacting surface into locking contact with the first wheel or tire also urges a wheel-contacting surface of the second wheel stop into contact with the second wheel or tire of the wheelchair. In this fashion, locking of both wheels of a wheelchair may be accomplished by actuating a single lever from a single side of the wheelchair, which provides a significant advantage to a user suffering from greater weakness in a particular hemisphere of the body, such as is common for stroke victims. The substantially continuously flexible linkage may comprise a flexible member such as a wire or cable having a first end operably connected to the first wheel stop and a second end operably connected to the second wheel stop.

Still other aspects of the present invention will become apparent to those skilled in this art from the following description wherein there is shown and described a preferred embodiment of this invention, simply by way of illustration of one of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWING

The accompanying drawing incorporated in and forming a part of the specification illustrate several aspects of the present invention and, together with the description, serve to explain the principles of the invention. In the drawing:

FIG. 1 is a perspective view of the wheelchair wheel immobilizer assembly of the present invention;

FIG. 2 is a side view of the wheelchair wheel immobilizer, showing the operating lever in use to lock a wheelchair wheel by both pushing and pulling;

FIG. 3 is a front view showing paired wheelchair wheel immobilizers installed on a conventional wheelchair;

FIG. 4 is a perspective view of the wheelchair wheel immobilizer assembly of the present invention installed on a conventional wheelchair; and

FIG. 5 is a perspective view of the wheelchair wheel immobilizer assembly of the present invention, showing a detent guide having a channel for receiving a pin on the detent.

Reference will now be made in detail to the presently preferred embodiment of the invention, an example of which is illustrated in the accompanying drawings.

### DETAILED DESCRIPTION OF THE INVENTION

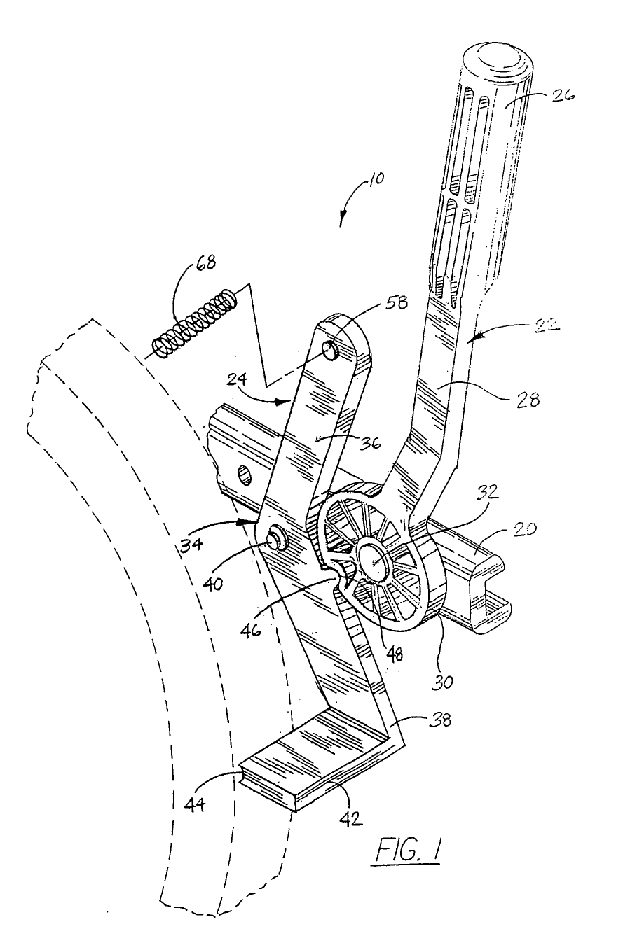

Referring to FIG. 1, in the depicted embodiment the wheel immobilizer 10 of the present invention comprises a mounting block 20 of a type well known in the art, an elongated lever 22, and a pivoting wheel stop 24. Mounting block 20 is adapted for connecting to an element of a wheelchair such as the frame (not shown). It will be appreciated by those of skill in the art that mounting block 20 may be fabricated to any desired configuration for mounting to a wheelchair in accordance with the manufacture of the wheelchair frame, such as by threaded nuts and bolts, clamps, and the like. Thus, the wheel immobilizer 10 of the present invention may be incorporated into the wheelchair during manufacture, or may be retrofitted to any existing manufacture of wheelchair. However, it should also be appreciated that the components of wheel immobilizer 10 could be directly attached to a wheelchair (not shown), such as by bolting to, e.g., the frame.

Lever 22 includes a gripping end 26, a central shaft 28, and a cam end 30, and is mounted to mounting block 20 such that cam end 30 may be rotated about a central axis point 32 by actuating lever 22. The components of wheel immobilizer 10 may be fabricated of any suitably durable, corrosion-resistant material commonly used to fabricate wheelchair wheel stops, including but not limited to metals such as aluminum and stainless steel, and suitably durable plastics or polymers.

Wheel stop 24 includes a body 34 having a first arm 36 and a second arm 38 which meet at a pivot point 40. First and second arm 36, 38 may extend from pivot point 40 to form an arcuate wheel stop 24. However, a configuration whereby first arm 36 and second arm 38 are oriented in a substantially linear configuration relative to one another will also be suitable for the invention. Wheel stop 24 further includes a wheel-contacting surface 42 which, when urged against a wheelchair wheel (depicted in broken lines for convenience), exerts sufficient force to substantially prevent rotation thereof. A cutout or recess 44 may be provided in the portion of wheel-contacting surface 42 facing the tire of a wheelchair wheel (shown in broken lines for convenience) which, as described in U.S. patent application Ser. No. 10/328,780 and copending PCT patent application S.N. PCT/US02/41082, significantly improves the gripping ability of wheel-contacting surface 42.

Wheel stop 24 further includes a detent 46 carried thereon. In the embodiment depicted in FIG. 1, detent 46 is carried on second arm 38. A corresponding receiver 48 is provided in cam end 30. In the unlocked or “wheels free” position as shown in FIG. 1, detent 46 seats in receiver 48, and wheel-contacting surface 42 does not contact the wheelchair wheel.

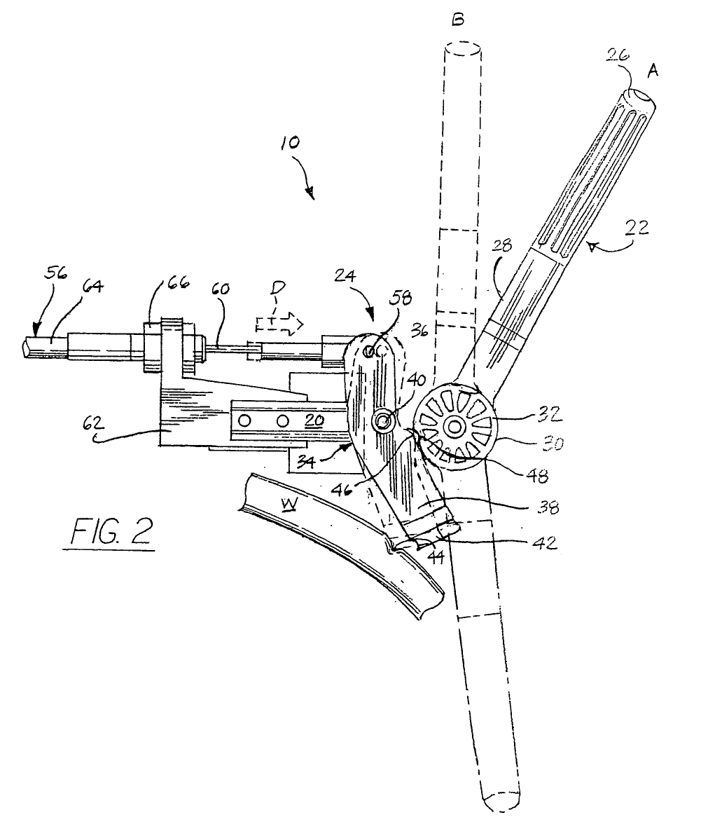

Turning to FIG. 2, the use of the wheel immobilizer 10 is shown. When lever 22 is placed in position A, detent 46 seats in receiver 48 and the wheel immobilizer is in the unlocked position as shown in FIG. 1. In the embodiment depicted herein, lever 22 may be actuated through a substantially 180 degree range of motion. However, it will be appreciated that the range of motion of lever 22 may be increased or decreased as desired or needed, in accordance with the configuration of wheel stop 24 or the design of the wheelchair to which the wheel immobilizer 10 is mounted.

Actuating lever 22 rotates cam end 30 and causes detent 46 to unseat from receiver 48 and contact an exterior circumference of cam end 30. This urges second arm 38 in the direction of the wheel W, forcing the wheel-contacting surface 42 against wheel W and substantially preventing rotation thereof. It will be appreciated that regardless of whether lever 22 is actuated towards position B or position C, detent 46 is unseated and the wheel W is locked. Only a limited motion of lever 22, i.e. only that sufficient to unseat detent 46, provides full locking of the wheel W. It is further to be appreciated that the wheel immobilizer 10 of this invention provides a simple, reliable push-pull locking mechanism which need not be disassembled and reconfigured to convert from the push function to the pull function, or vice-versa. Thus, regardless of whether it is easier for a particular user to apply a pushing or pulling motion, the same wheel immobilizer 10 may lock the wheel of the wheelchair without necessitating reconfiguration.

A further feature of the wheel immobilizer 10 of this invention is now revealed. Lever 22 has a range of motion as described above. Regardless of whether the lever 22 is actuated towards position B or C to lock the wheelchair wheel W, because of the range of motion of lever 22 it may be placed in a substantially vertical orientation, with gripping end 26 either pointing upwardly or downwardly, without in any way altering the stopping force applied to the wheel W. Thus, when wheel W is locked the lever 22 may be placed in a convenient storage position, whereby the risk of a user accidentally freeing the wheel is minimized, by simply placing lever 22 in the orientation as described above. Returning lever 22 to position A whereby detent 46 reseats in receiver 48 releases the wheel from locking contact with wheel-contacting surface 42.

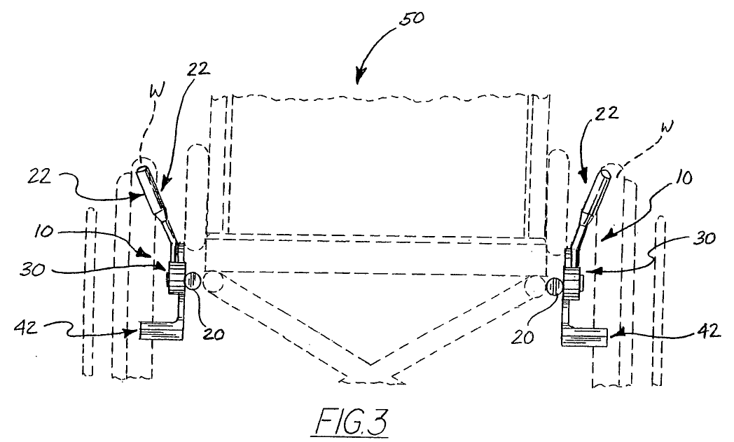

In another aspect of the present invention shown in FIG. 3, a wheel locking assembly 50 is provided comprising first and second wheel immobilizers 10 as described above. Each wheel immobilizer 10 is mounted to opposed sides of a wheelchair frame (shown in broken lines) using mounting blocks 20 such that wheel contacting surfaces 42 are in spaced proximity to the wheels W of the wheelchair, whereby actuating levers 22 urges wheel-contacting surfaces 42 into locking contact with wheels W in the manner described above. Typically, the wheel immobilizers 10 will be mounted in proximity to the drive wheels of the chair. In this embodiment, paired wheel immobilizers 10 may be independently actuated by a user to separately lock the wheels W.

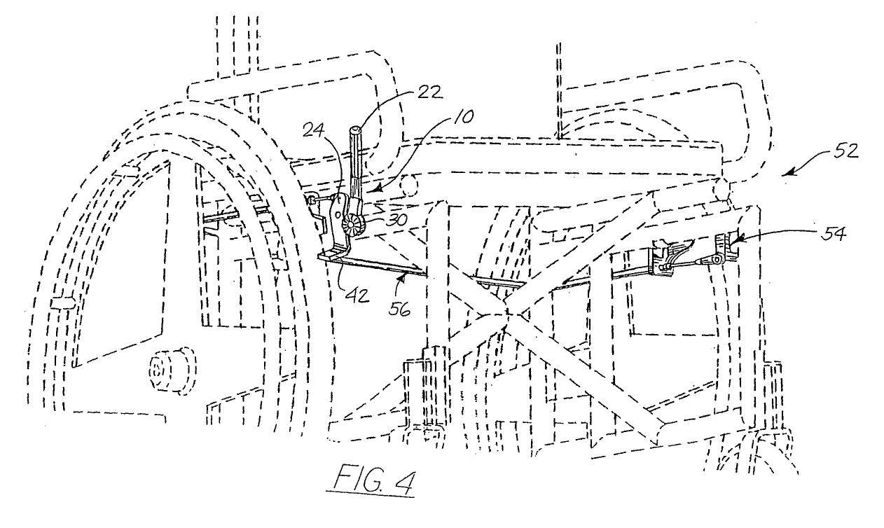

In yet another embodiment of the present invention, shown in FIG. 4, a wheel locking assembly 52 is provided wherein actuation of a single wheel immobilizer 10 locks two wheels of a wheelchair in a single motion. Wheel locking assembly 52 includes a first wheel immobilizer 10, substantially as described above, and a second wheel immobilizer 54 operably connected to the first wheel immobilizer 10.

First wheel immobilizer 10 and second wheel immobilizer 54 are operably connected by a substantially continuously flexible linkage 56 in a manner which will be described in greater detail below. As shown in FIG. 4, first and second wheel immobilizers 10, 54 may be mounted to opposite sides of a wheelchair frame (shown in broken lines for convenience) whereby wheel-contacting surfaces 42 are in substantial proximity to the wheels W of the chair as described above. First wheel immobilizer 10 may be mounted to either side of the wheelchair, with second wheel immobilizer 54 being mounted to the opposed side, such as by suitable mounting brackets (not shown in this view). Flexible linkage 56 may be routed around or through the wheelchair frame in any desired fashion whereby it does not interfere with use of the chair.

First arm 36 may include an aperture 58 at an end thereof. A wire 60 may be connected to first arm 36 via aperture 58 by any suitable means, such as a bolt and screw, a pin or in the alternative may be directly welded to first arm 36. Advantageously, wire 60 may be attached to aperture 58 using a pivoting fitting to accommodate the motion of first arm 36. Alternatively, in the embodiment depicted in FIG. 2, the mounting bracket 20 may further include a support 62 connected thereto, such as by threaded nut and bolt assemblies, by welding, or as an integral portion of mounting bracket 20. As shown in FIG. 2, substantially continuously flexible linkage 56 may comprise a hollow sheath 64 surrounding and spaced from a wire 60 slidably inserted in the interior of hollow sheath 64.

Hollow sheath 64 may be connected to support 62 by a threaded fitting 66, allowing easy installation, removal, and replacement thereof. However, it will be appreciated that any suitable substantially continuously flexible linkage 56 for operably connecting first wheel immobilizer 10 and second wheel immobilizer 54, and means for supporting same on the wheelchair frame, such as a wire 60 and a plurality of eyelets (not shown) guiding flexible linkage 56 from first wheel immobilizer 10 to second wheel immobilizer 54, may be utilized for the present invention.

Any suitable wheel immobilizer may serve as second wheel immobilizer 54 for the purposes of the present invention. Preferably, a wheel immobilizer will be employed which is substantially similar to the second wheel stop described in U.S. patent application Ser. No. 10/328,780 and PCT patent application S.N. PCT/US02/41082, the disclosures of which have already been incorporated in their entirety by reference. As described therein, the second wheel immobilizer may comprise a mounting block and a pivoting wheel stop having a wheel contacting surface thereon. Substantially continuously flexible linkage 54 may be connected to the second wheel immobilizer wheel stop by any of the methods described above, whereby linkage 54 may urge second wheel immobilizer wheel stop into locking contact with the second wheel W.

As described above and referring again to FIG. 2, actuating lever 22 in either the forward or backward direction rotates cam end 30 and unseats detent 46, urging wheel-contacting surface 42 of wheel stop 24 into locking contact with wheel W. It will be appreciated that as second arm 38 travels towards the wheel W, first arm 36 travels in the opposite direction, shown in FIG. 2 as arrow D. A pulling force is thus transmitted to wire 60 which transfers to second wheel immobilizer 54, urging the wheel-contacting surface of second wheel immobilizer 54 into contact with the second wheel of the chair, thereby preventing rotation thereof.

In one embodiment, a push-pull cable of a type known in the art may be used as the substantially continuously flexible member 54. In this embodiment, wire 60 retains the feature of flexibility but is not only strong enough to pull the second wheel immobilizer wheel stop into locking contact with second wheel W, but to push the wheel stop away from second wheel W when first wheel W is released in the manner described above.

Accordingly, it will be appreciated that control of both wheel immobilizers 10, 54 may be independently effected from a single side of a wheelchair, providing convenience and safety to users having increased weakness in one hemisphere of the body. In the event that flexible linkage 56 is severed, first wheel immobilizer 10 is still capable of effecting locking of one wheelchair wheel, thus improving the effectiveness of the wheel locking assembly 52 of this invention.

There is accordingly provided by the present invention a simple and reliable wheel immobilizer mechanism allowing a push-pull mechanism without the concomitant inconvenience of having to disassemble and reassemble the immobilizer to convert from a pushing mechanism to a pulling mechanism as is the case with conventional push-pull wheel locks. The wheel immobilizer of the present invention may be retrofitted to any existing design of manually operated wheelchair, and may be incorporated into a wheel locking assembly comprising either paired, independently operated wheel immobilizers or an assembly wherein dual wheel immobilizers may be operated using a single control.

In the embodiments shown in FIGS. 1 and 3, means for maintaining contact between detent 46 and an exterior circumference of cam end 30 are provided. As shown in FIG. 1, the wheel immobilizer 10 may include a biasing spring 68 connected at a first end to first arm 36 of wheel stop 24 and at a second end to a fixed point, such as mounting block 20, support 62, or the frame of the wheelchair, whereby the spring biases the wheel stop 24 to pivot the wheel-contacting surface 42 away from locking contact with the wheelchair wheel when detent 46 is aligned with receiver 48. Spring 68 also ensures constant contact between detent 46 and the exterior circumference of cam end 30. Actuating lever 22 to rotate cam 30 and unseat detent 46 in the manner described above temporarily overcomes the biasing force of spring 68, and allows wheel-contacting surface 42 to contact with and lock the wheel. When lever 22 is returned to the position where detent 46 reseats in receiver 48, the biasing spring 68 assists in pivoting wheel stop 24 to remove wheel-contacting surface 42 from locking contact with the wheel.

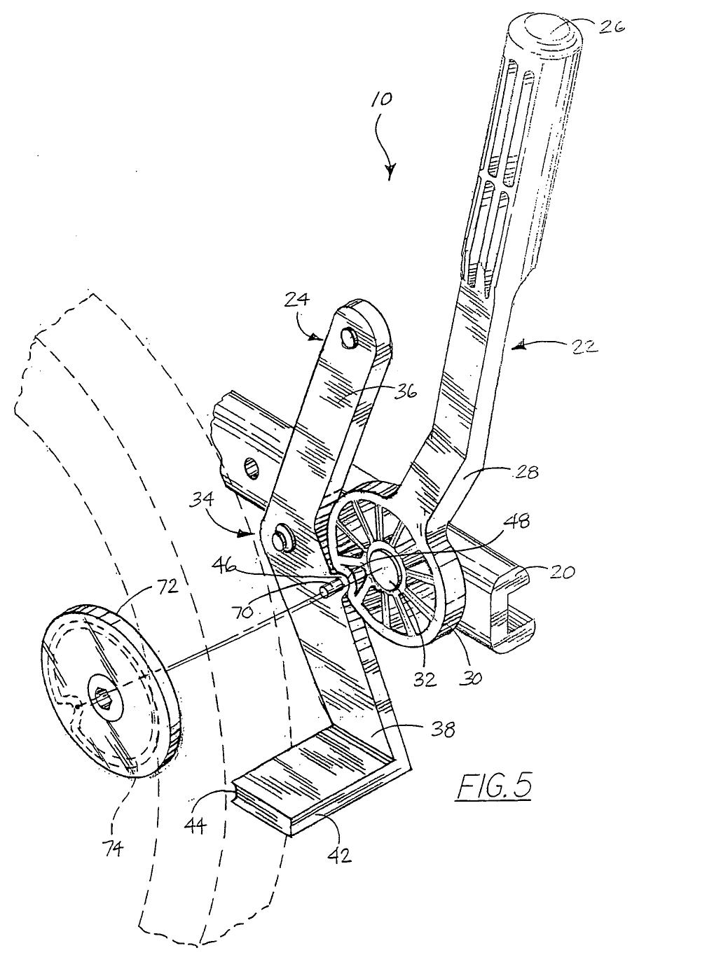

The foregoing description of a preferred embodiment of the invention has been presented for purposes of illustration and description. It is not intended to be exhaustive or to limit the invention to the precise form disclosed. Obvious modifications or variations are possible in light of the above teachings. For example, rather than the biasing spring 68 as described above, a guide system as shown in FIG. 5 may be provided. In this embodiment, detent 46 may include a pin or stud 70 projecting therefrom. A guide 72 may be provided, having a channel 74 in an exterior circumference thereof. The diameter of guide 72 is slightly greater than the diameter of cam end 30, whereby as shown in FIG. 5 channel 74 substantially traces the exterior circumference of cam end 30, including the indentation formed therein by receiver 48.

Guide 72 may be secured to cam end 30, for example by providing a threaded aperture at pivot point 32 and bolting guide 72 thereto. Alternatively, guide 72 and cam end 30 may be manufactured as a unit. When guide 72 is secured to cam end 30, pin 70 is received in channel 74. Actuating lever 22 to cause cam end 30 to rotate will cause pin 70 to travel along channel 74. As long as pin 70 remains in the portion of channel 74 corresponding to receiver 48, wheel-contacting surface 24 will not contact the wheel. However, when lever 22 is actuated sufficiently to cause pin 70 to travel out of the portion of channel 74 corresponding to receiver 48, it will be appreciated that detent 46 will similarly travel, urging wheel-contacting surface 42 into locking contact with the wheel. In yet another embodiment, friction-reducing means (not shown) such as for example a roller bearing may be interposed between detent 46 and cam end 30, thereby reducing frictional contact therebetween and reducing wear on the surfaces of cam end 30 and detent 46.

The embodiment described was chosen to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

1. A wheel immobilizer for substantially preventing rotation of a wheelchair wheel or tire about a central axis thereof, comprising:
a pivoting wheel stop including a detent;
a rotating cam having a receiver for receiving the detent when the wheel immobilizer is in an unlocked position with the wheel stop held at a spaced distance from the wheel to allow rotation thereof; and
a lever operably connected to the cam;
whereby actuating the lever rotates the cam and urges the detent from the receiver, urging a wheel-contacting surface of the wheel stop into locking contact with the wheel.

2. The wheel immobilizer of claim 1, wherein the cam is substantially circular in shape.

3. The wheel immobilizer of claim 1, wherein the lever includes a first, gripping end, a central shaft, and a second, cam end having a receiver for receiving the detent when the wheel immobilizer is in an unlocked position with the wheel stop held at a spaced distance from the wheel to allow rotation thereof.

4. The wheel immobilizer of claim 3, wherein the cam end is substantially circular in shape.

5. The wheel immobilizer of claim 1, wherein the wheel stop, cam, and lever are supported by a mounting block adapted for mounting to a frame of a wheelchair.

6. A wheel locking assembly for substantially preventing rotation of a wheelchair wheel or tire about a central axis thereof, comprising:
a first and a second wheel immobilizer respectively held at a spaced distance from a first and second wheel of a wheelchair, each wheel immobilizer including a pivoting wheel stop including a detent, a rotating cam having a receiver for receiving the detent when the wheel immobilizer is in an unlocked position with the wheel stop held at a spaced distance from the wheel to allow rotation thereof, and a lever operably connected to the cam;
whereby actuating the lever rotates the cam and urges the detent from the receiver, urging a wheel-contacting surface of the wheel stop into locking contact with the wheel.

7. The wheel locking assembly of claim 6, wherein the cam is substantially circular in shape.

8. The wheel locking assembly of claim 6, wherein the operating lever includes a first, gripping end, a central shaft, and a second, cam end having a receiver for receiving the detent when the wheel immobilizer is in an unlocked position with the wheel stop held at a spaced distance from the wheel to allow rotation thereof.

9. The wheel locking assembly of claim 8, wherein the cam end is substantially circular in shape.

10. The wheel locking assembly of claim 6, wherein the wheel stop, cam, and lever are supported by a mounting block adapted for mounting to a frame of the wheelchair.

11. A wheel locking assembly for substantially preventing rotation of a wheelchair wheel or tire about a central axis, comprising a first wheel immobilizer and a second wheel immobilizer for mounting to a wheelchair frame at a spaced distance from a first and second wheel of a wheelchair:
wherein the first wheel immobilizer includes a first pivoting wheel stop carrying a detent, a rotating cam having a receiver for receiving the detent when the wheel immobilizer is in an unlocked position with the wheel stop held at a spaced distance from the wheel to allow rotation thereof, and a lever operably connected to the cam, whereby actuating the lever rotates the cam and urges the detent from the receiver, urging a wheel-contacting surface of the wheel stop into locking contact with the wheel; and
the second wheel immobilizer includes a second pivoting wheel stop operably connected to the first wheel stop by a substantially continuously flexible linkage;
whereby actuating the lever to urge the first wheel stop wheel-contacting surface into locking contact with the first wheel or tire also urges a wheel-contacting surface of the second wheel stop into contact with the second wheel or tire of the wheelchair.

12. The wheel locking assembly of claim 11, wherein the substantially continuously flexible linkage comprises a flexible member having a first end operably connected to the first wheel stop and a second end operably connected to the second wheel stop.

13. The wheel locking assembly of claim 12, wherein the flexible member is a wire or cable.
